(19) United States
(12) Patent Application Publication
(10) Pub. No.: US 2013/0248486 A1
(43) Pub. Date: Sep. 26, 2013

(54) ELECTRON BEAM POLISHING OF ALUMINUM

(71) Applicant: APPLE INC., Cupertino, CA (US)

(72) Inventors: SIMON R. LANCASTER-LAROCQUE, Gloucester (CA); Purwadi RAHARJO, Niigata (JP); Kensuke UEMURA, Kanagawa (JP)

(73) Assignee: Apple Inc., Cupertino, CA (US)

(21) Appl. No.: 13/626,884

(22) Filed: Sep. 26, 2012

Related U.S. Application Data
(60) Provisional application No. 61/614,783, filed on Mar. 23, 2012.

(51) Int. Cl. B23K 15/00; B44C 1/22

(52) U.S. Cl. CPC B23K 15/0013; B44C 1/227
USPC 216/53; 216/94; 156/345.11; 156/345.12; 219/121.19

(57) ABSTRACT

A highly polished surface on an aluminum substrate is formed using any number of machining processes. During the machining process, intermetallic compounds are typically generated at a top surface area of the aluminum substrate caused by spot heat generated between the tool edge and the cut tip of the aluminum substrate during the cutting process. The intermetallic compounds can leave surface imperfections after conventional mechanical polishing operations that render the surface of the aluminum substrate difficult to obtain a desired high glossiness due to exfoliation of the intermetallic compounds from the top surface. In order to remove the effect of the intermetallic compounds, an electron beam is applied to the surface resulting in Joule heating to melt down a top surface zone. In this way, any tooling traces and intermetallic compounds are eliminated.

### BACKGROUND

1. Technical Field

The described embodiments relate generally to surface treatment of metals. In particular, electron beam polishing of an aluminum substrate is described.

2. Related Art

In some cases extruded aluminum blocks require a machining process to be applied to achieve a shape more closely resembling a desired geometry. During that machining process, intermetallic compounds are typically generated at a top surface area of the aluminum block caused by spot heat generated between the tool edge and the cut tip of the aluminum block during the machining process. The intermetallic compounds can cause surface imperfections (referred to as “orange peels”) to be left behind after conventional polishing. These orange peels render the surface of the aluminum block difficult to polish to a desired high glossiness and miller surface due to exfoliation of the intermetallic compounds from the top surface during mechanical polishing operations.

Therefore, what is desired is a technique for polishing aluminum parts in a manufacturing efficient manner.

### SUMMARY

This paper describes various embodiments that relate to a method, apparatus, and computer readable medium for non-mechanical polishing of aluminum.

In a first embodiment a method of polishing a surface of an aluminum part, including at least the following steps: (1) chemically pre-treating the aluminum part by acid etching the aluminum part; and (2) electron beam processing the acid etched surface of the aluminum part by an electron beam. The electron beam processing is characterized by an accelerating voltage of the electron beam between about 10 and 25 kV, an electron beam pulse duration between about 50 and 150 micro seconds, and an electron beam pulse frequency between about 1 and 10 Hz. The electron beam processing also includes scanning a surface portion of the aluminum part with the electron beam. A resulting surface melt of the surface of the aluminum part eliminates substantially all intermetallic compounds and substantially enlarges grain boundaries of the surface of the aluminum part.

In another embodiment an electron beam polishing machine configured to polish an aluminum part is disclosed. The electron beam polishing machine includes at least the following: (1) an electron beam emitter; (2) a vacuum chamber; and (3) a jig configured to translate the aluminum part in at least two axes. The electron beam emitter is configured to operate during an electron beam polishing operation with an accelerating voltage of between about 10 and 25 kV, a pulse duration of between about 50 and 150 micro seconds, and a pulse frequency of between about 1 and 10 Hz. The translation of the aluminum part causes an emitted electron beam to scan across a surface of the aluminum part, causing a resulting surface melt of the surface of the aluminum part, thereby eliminating substantially all intermetallic compounds and substantially enlarging grain boundaries of the surface of the aluminum part.

In yet another embodiment a polishing assembly for polishing an aluminum part is disclosed. The polishing assembly includes at least the following: (1) a means for acid etching the aluminum part; (2) a means for configuring an electron beam with a set of operating parameters, the operating parameters including an accelerating voltage of between about 10 and 25 kV, a pulse duration of between about 50 and 150 micro seconds, and a pulse frequency of between about 1 and 10 Hz; (3) a means for activating the electron beam; and (4) a means for maneuvering an aluminum part through the electron beam so that the electron beam scans across substantially all of a surface of the aluminum part.

### BRIEF DESCRIPTION OF THE DRAWINGS

The embodiments will be readily understood by the following detailed description in conjunction with the accompanying drawings, wherein like reference numerals designate like structural elements, and in which:

FIG. 1A shows an extruded aluminum part that has been surface machined alongside a titanium alloy plate;

FIG. 1B shows titanium alloy plate with a number of aluminum parts arranged within it and covered by a mesh of iron wires;

FIG. 1C shows a titanium alloy plate loaded with aluminum parts and placed within a plate holder;

FIG. 1D shows a number of titanium plates inserted into the plate holder;

FIG. 2 shows an illustrated process for acid etching aluminum parts arranged inside a plate holder;

FIG. 3A shows a line graph illustrating surface contour of one cross-section of an extruded aluminum substrate after surface tooling has been applied to it, but before an acid etching process;

FIG. 3B shows a line graph illustrating effects on the surface contour of the aluminum substrate after an ionization treatment is applied to the aluminum substrate for about 8 minutes;

FIG. 3C shows a line graph illustrating effects on the surface contour of the aluminum substrate after an ionization treatment is applied to the aluminum substrate for about 15 minutes;

FIG. 4 shows a block diagram of an electron beam polishing machine;

FIG. 5 shows a cross-sectional side view of a heat transporting fixture adapted to retain the shape of a thin aluminum housing;

FIG. 6 shows a perspective view of one embodiment of an electron beam polishing machine;

FIG. 7A shows perspective view of a jig configured to maneuver aluminum parts during an electron beam polishing operation.

FIG. 7B shows a close up perspective view of a jig fastener;

FIGS. 8A-8C show side views of jig fastener rotating an aluminum part through an axis of rotation;

FIG. 9 shows EPMA based top surface views and side cross-sectional views of an aluminum substrate before and after electron beam polishing operations;

FIG. 10A shows a cross-sectional side view of a machined aluminum substrate prior to an electron beam polishing operation;

FIG. 10B shows a cross-section side view of a machined aluminum substrate subsequent to an electron beam polishing operation;

FIGS. 11A-11B show parameter diagrams for an electron beam polishing machine useful in polishing aluminum;

FIG. 12 shows a high level block diagram describing a forming and polishing process for extruded aluminum parts; and

FIG. 13 shows an electronic device that can be used in conjunction with the described embodiments.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

In some cases extruded aluminum parts can be formed in a shape closely matching the geometry of a finished part. Unfortunately the extrusion process generally results in surface cuts and nicks exceeding a maximum depth where polishing and surface finishing alone does not fully remove such flaws. A standard practice in industry is to extrude the blocks at a size somewhat larger than otherwise desired so that a machining process can be applied to effectively remove large defects in the aluminum part. The surface machining process can include machining features into the surface of the aluminum part such as rounded corners. Alternatively corners can also be rounded at later points in a finishing operation by for example a sanding operation. Even though the machining process tends to reduce the occurrence of large defects or pits in the surface of the aluminum part, the machining process can still leave significant ridges and tooling lines that can make polishing problematic. In this case an acid bath process can be introduced in which machining artifacts such as ridges or pits are removed or substantially reduced. An acid bath can also be effective at removing any oxide layer that has formed over the aluminum. While the acid bath does smooth the overall surface of the part a collection of intermetallic compounds can still remain embedded in the surface of the aluminum part as a result of the surface machining process. During the surface machining process, intermetallic compounds are typically generated at a top surface area of the aluminum substrate caused by spot heat generated between a tool edge and a cut tip of the aluminum part during the cutting process. The intermetallic compounds formed are generally along the lines of an Aluminum Iron alloy such as Al₃Feₓ. In some cases trace amounts of Silicone can also be found in the intermetallic compounds. Intermetallic compounds tend to have small grains and also tend to include numerous different alloys, thereby resulting in a surface portion which can include widely different material properties along an outer surface portion of the aluminum part. Consequently, surface processing the aluminum parts can be quite difficult due to these differing material properties. Conventional machining operations can result in the formation of surface imperfections (sometimes referred to as orange peels) that tend to flake off or exfoliate during a mechanical polishing operation. A relatively wide beam electron beam polishing process can be used to dissolve or evaporate intermetallic compounds within 10-20 microns of the surface of the aluminum part. In this way a homogenous surface can be created along the surface of the aluminum part making subsequent polishing or buffing much easier to achieve.

In one embodiment a chemical etching process can be utilized. The chemical etching process involves inserting the aluminum part into an acid bath. The acid bath can have the effect of removing surface artifacts (such as burrs) and surface oxides. In one particular arrangement, the acid bath process can include supporting a number of aluminum parts in a plate formed of an alloy of titanium, graphite or mild steel. The plate (and part therein) can then be immersed into an acid bath that includes a solution of phosphoric acid (H₃PO₄: 66-71 wt %), and nitric acid (HNO₃: 5-9 wt %) at a temperature of about 60° C. to about 75° C. A galvanic potential gap voltage between the aluminum part and the metal alloy cage generates an electron concentration on a portion of the aluminum part that is then dissolved in the mixed acid by vibrating the metal alloy cage holder in the acid bath for between about 5 and 15 minutes. Because the chemical etching process is not mechanical in nature it does not tend to cause the orange peeling process generally associated with intermetallic compounds and mechanical polishing. In some applications the chemical etching process can provide a sufficiently smooth surface finish to forgo additional surfacing operations. In this case a protective layer such as an anodization layer can be applied to the polished aluminum surface subsequent to the chemical etching process.

In another embodiment an electronic beam polishing step can be performed subsequent to the chemical etching step. While electron beams have been used to polish steel and titanium alloys they have not been previously used to polish aluminum. Electron beams configured to polish titanium and steel generally have a diameter of about 0.5 mm while it has been discovered in the case of aluminum a diameter of between about 20 mm and 30 mm is more appropriate due in part to the softness of aluminum. In many cases additional cooling is also required to keep the aluminum from being excessively heated. One such case is when an aluminum enclosure requires machining. In such a case a water cooled heat exchanger can be required to prevent the enclosure from deforming due to heat buildup caused by the electron beam. The electron beam accomplishes its polishing step by scanning across the surface of an aluminum part. During its scan the electron beam heats the surface of the aluminum part to a temperature sufficient to cause evaporation or dissipation of intermetallic compounds embedded within the surface of the aluminum part. In this way a substantially homogenous surface can be created free of intermetallic compounds down to a depth of about 10-20 microns. The electron beam is also capable of affecting off-axis surfaces; however, at about 30 degrees performance drops off quickly. By attaching the aluminum parts to a jig during the electron beam processing step various surfaces of the aluminum part can be re-oriented towards the electron beam during the polishing process, thereby allowing multiple faces of an aluminum part to be electron beam polished at any given time. Furthermore, the off-axis beam performance also allows polishing of surfaces with significant curvatures. In one set of trials only about 1 minute of exposure was required to properly polish a batch of aluminum parts. After the electron beam polishing operation is complete a mechanical buffing and polishing operation can be initiated since the intermetallic compounds have been removed from the surface of the aluminum part. This allows the surface of the aluminum part to attain a high glossiness and miller surface.

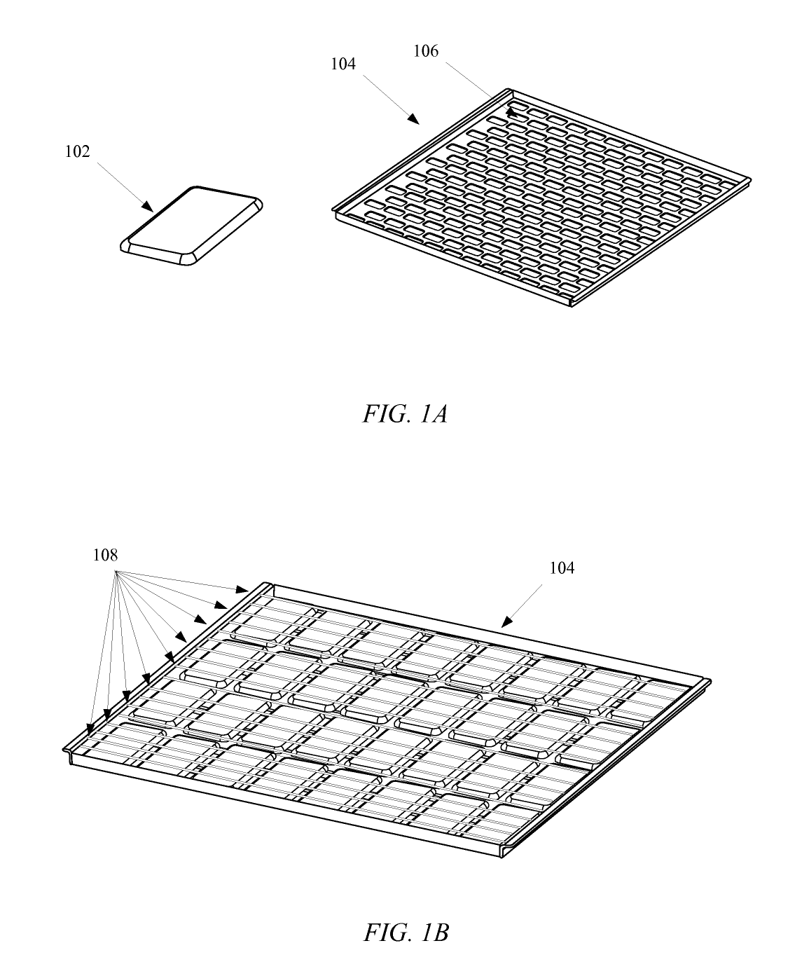

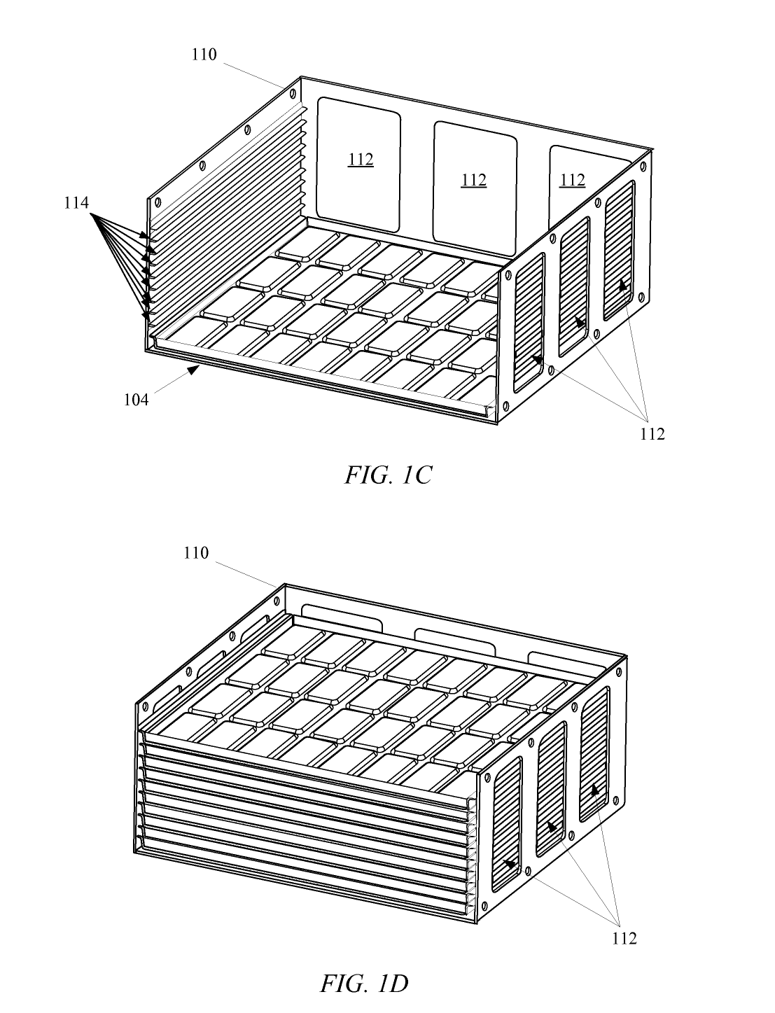

These and other embodiments are discussed below with reference to FIGS. 1A-13; however, those skilled in the art will readily appreciate that the detailed description given herein with respect to these figures is for explanatory purposes only and should not be construed as limiting.

FIGS. 1A-1D show a process for loading a large batch of aluminum parts into a plate holder prior to an acid etching operation. An acid etching operation can have the effect of removing surface artifacts, such as burrs and surface oxides. In FIG. 1A an extruded aluminum part 102 that has been surface machined is shown alongside titanium alloy plate 104. As depicted titanium alloy plate 104 can include a number of perforations 106 disposed in a bottom surface of titanium alloy plate 104, thereby allowing fluids easier access to aluminum parts 102 during an acid etching operation. In some embodiments aluminum part 102 can be hollowed out while in others it can be a solid aluminum part. It should be noted that in some alternative embodiments titanium alloy plate 104 can be constructed from mild or low carbon steel instead of from titanium alloy. Titanium alloy plate 104 can hold a number of aluminum parts 102 as shown in FIG. 1B. In one embodiment titanium alloy plate 104 can include a mesh of iron (Fe) wires 108 running across a lower surface and/or upper surface of aluminum parts 102, also as depicted. Iron wires 108 can enhance performance of the acid etching process by helping to concentrate aluminum removal on protrusions along a surface portion of the aluminum parts. In some embodiments only parallel wires are employed as depicted, while in other embodiments a matrix of vertically and horizontally running iron wires 108 can be employed thereby minimizing distances between surface portions of aluminum parts 102 and iron wires 108. FIG. 1C depicts loaded titanium alloy plate 104 placed in plate holder 110. Plate holder 110 can include fluid access openings 112 disposed around plate holder 110, easing entry of fluid into and out of plate holder 110. Also depicted in FIG. 1C are plate support racks 114 arranged along two opposing sides of plate holder 110. Plate support racks 114 allow a number of titanium alloy plates 104 to be conveniently inserted and removed from plate holder 110. FIG. 1D shows a number of titanium alloy plates 104 inserted into plate holder 110. This allows for a large number of titanium alloy plates 104 and consequently even larger number of aluminum parts 102 to be simultaneously processed during a single acid etching process, thereby allowing the acid etching process to be an efficient one.

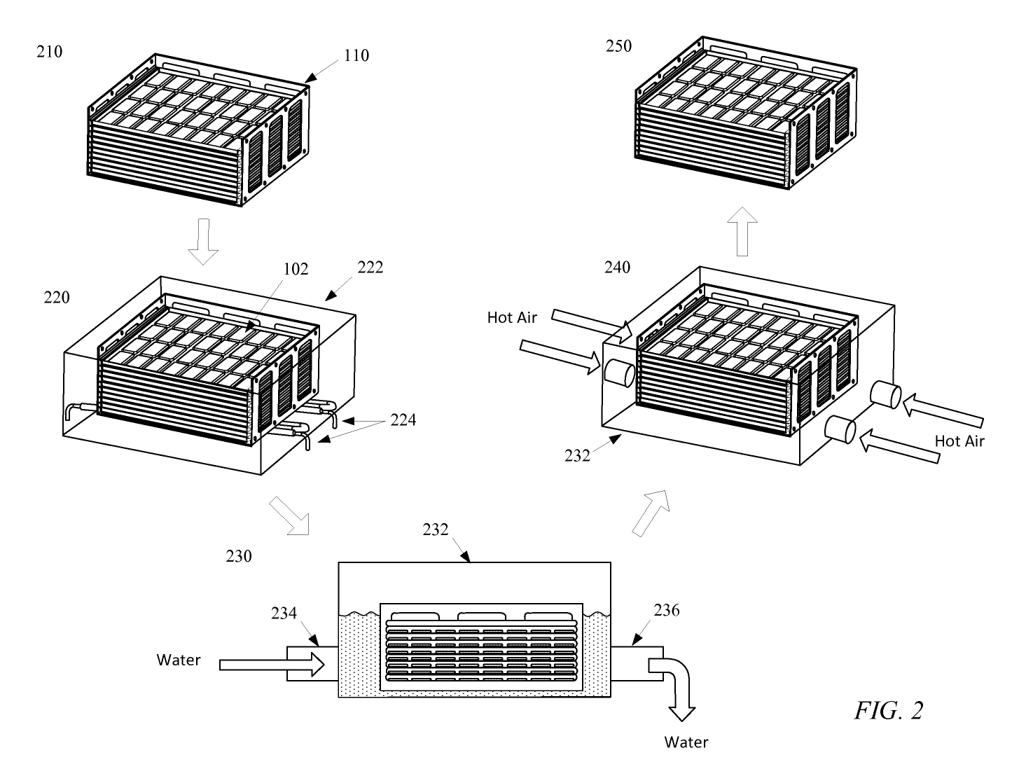

FIG. 2 illustrates an acid etching process 200. In a first step 210 plate holder 110 is filled with a number of titanium alloy plates 104 as described in reference to FIGS. 1A-1D. In step 220 acid etching tank 222 is filled with a mixed acid bath including the following acids: Phosphoric Acid (H₃PO₄: 66-71 wt %); and Nitric Acid (HNO₃: 5-9 wt %). The acid bath temperature is set to between about 60° C. and 75° C. A series of heat exchangers 224 can be used to set the temperature of the acid bath prior to placing plate holder 110 within acid etching tank 222 so that all portions of the acid etching process can occur at a fixed temperature. Once a working temperature of the acid bath has been achieved plate holder 110 is placed in acid etching tank 222. Acid etching tank 222 can be a double walled tank well suited to prevent corrosion of inner surfaces of acid etching tank 222. Acid etching tank 222 can also include an agitator, or churning wheel designed to churn acid within acid etching tank 222 circulating acid through various portions of acid etching tank 222. Acid etching tank 222 also includes a mechanical vibration apparatus for creating motion between aluminum parts 102 and iron wires 108 (not shown). Vibrations facilitate generation of a solid state electrode potential gap without any current being applied from a power source, as is generally required for more conventional electro-polishing operations. Titanium alloy plates 104 act as an anode while aluminum parts 102 act as a cathode during the reaction generating a voltage of about 0.8 V between the aluminum and titanium alloy. In this way an electron concentration forms on convex surface protrusions found along a surface portion of aluminum parts 102 that is subsequently dissolved in the mixed acid bath. The actual chemical reactions occur according to the following process. Exposure of aluminum parts to the nitric acid within the mixed acid bath causes oxidation of the aluminum to oxidize in accordance with Equation 1:

2 Al+6 HNO₃→Al₂O₃+3 H₂O+6NO₂ Equation 1:

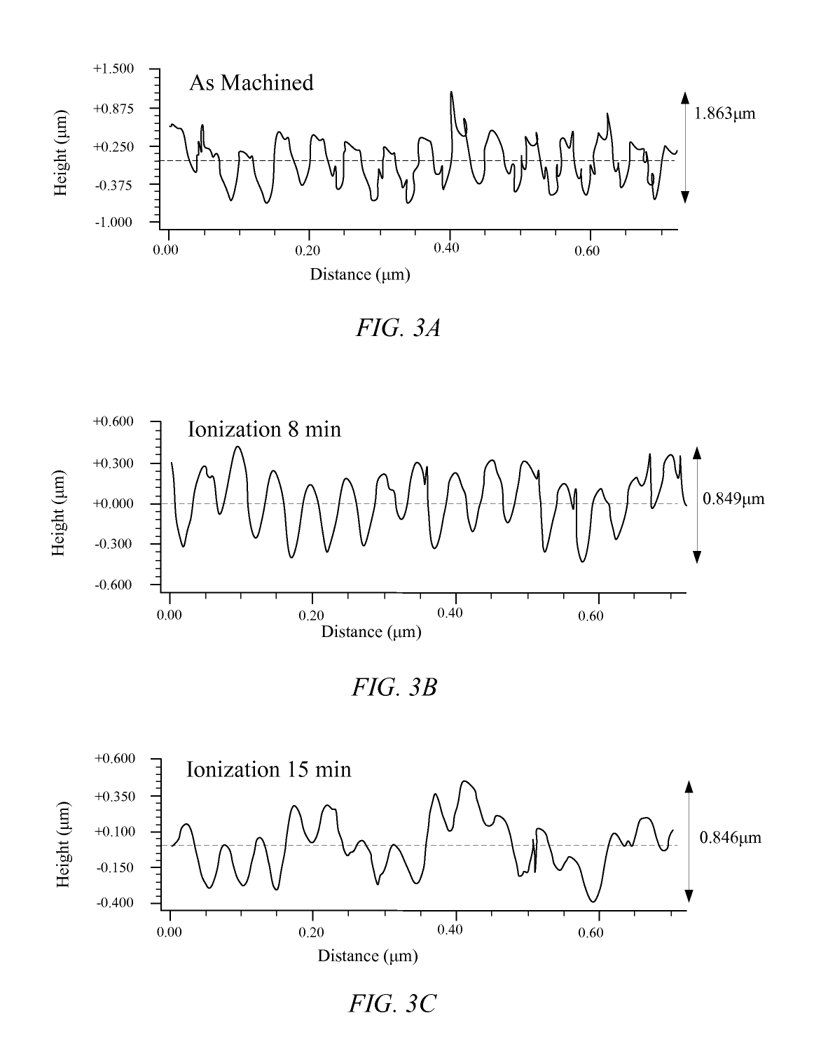

After an aluminum oxide layer forms the phosphoric acid dissolves the oxidized aluminum (Al₂O₃). The cycle of oxidation and dissolving continues while aluminum blocks 102 are immersed in the mixed acid bath; however, since a natural galvanic potential gap voltage of 0.8 V exists between aluminum blocks 102 and titanium alloy plates 104 removal of electrons from the surface of aluminum blocks 102 are as previously stated concentrated along convex protrusion resulting in substantial polishing of the affected surface. Such a natural electro-polishing process can produce a more homogenous surface finish of the aluminum when compared to a more conventional electro-polishing process. In more conventional electro-polishing processes an externally applied current can be inadvertently concentrated non-uniformly resulting in undesirable surface variation. Acid etching step 220 can be carried out for a duration of between about 5 and 25 minutes. During that time electron concentrations can be removed from a surface portion of aluminum parts 102. Profile normalization results are further detailed in FIGS. 3A-3C. In step 230 after an ionization based chemical etching process is completed the acid bath can either be drained and rinsed with water or tray holder 110 can be moved to a water based neutralization tank 232 during which tray holder 110 and associated aluminum parts 102 can be rinsed free of any acid residue. Rinsing and flushing can be accomplished by forcing water through inlet 234 and back out of outlet 236 of neutralization tank 232. In a subsequent step 240 hot air can be blown through neutralization tank 232 after being drained, resulting in a gradual drying of aluminum parts 102 at final step 250.

FIGS. 3A-3C show graphs representing an outside surface of an aluminum substrate before and after an ionization based chemical etching process. FIG. 3A shows a surface contour of one cross-section of an extruded aluminum substrate after surface tooling has been applied to it. The vertical axis shows height of the surface of the aluminum substrate in microns, and the horizontal axis shows that this particular graph represents a 0.7 micron wide stretch of the surface. The surface contour as shown by the graph in FIG. 3A includes numerous sharp peaks and valleys that in some instances create a depth gradient of nearly 2 microns. Such large gradients in depth tend to negatively impact a surface finish of the aluminum substrate. FIG. 3B shows effects on the surface of the aluminum substrate after an ionization treatment is applied to the aluminum substrate for about 8 minutes. Perhaps most noticeably the depth gradient is greatly reduced from 1.863 microns in FIG. 3A to 0.849 microns in FIG. 3B, for a reduction of greater than 50%. It should also be noted that the valleys and peaks are more evenly sloped, the sharp peaks and valleys being noticeably absent. In FIG. 3C the ionization treatment is allowed to continue for a total of 15 minutes. While the depth gradient is further reduced from the additional time, the results are not as dramatic as those achieved in just 8 minutes. The depth gradient in this case is reduced to only 0.846 microns. Consequently, a shorter time may be desirable in cases where efficiencies in manufacturing timelines are desirable. For example, in one set of trials an ionization time of only 5 minutes was found to be optimal when combined with an electron beam polishing operation which will be discussed in further detail below.

While the ionization based chemical etching process can substantially improve a surface finish across a surface portion of aluminum parts 102 it does not solve the problem of intermetallic particles arranged along the surface, since the acid etch comes in contact only with a surface portion of aluminum parts 102. Subsequent mechanical polishing across the surface of an acid etched aluminum part 102 can still result in exfoliation of intermetallic particles embedded just below a surface portion of aluminum parts 102, thereby preventing or at least substantially hindering an effective mechanical polishing operation. In cases where a finer polish is required than can be obtained by the ionization based chemical etching process a subsequent electron beam polishing process can be applied.

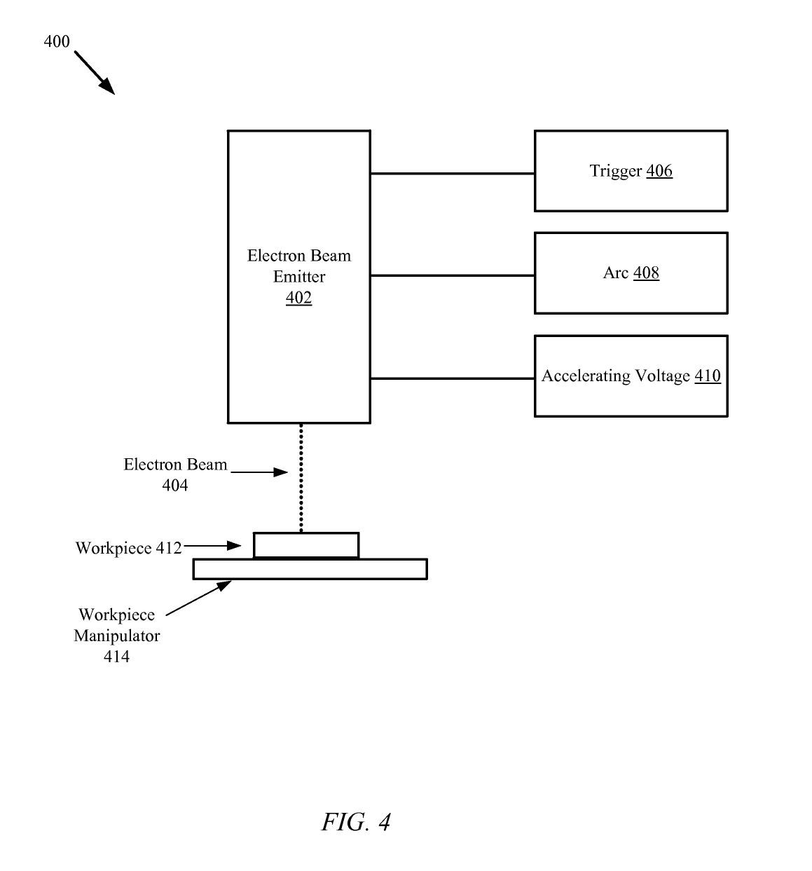

In FIG. 4 a block diagram of an electron beam polishing machine 400 is displayed. The electron beam emitted from the plasma cathode is about 20 mm in diameter. One specific electron beam embodiment than can be used with the present embodiments is well described in papers [V. N. Devjatkov et al, Installation for Treatment of Metal Surface by Low Energy Electron Beam, 7th International Conference on Modification of Materials with Particle Beams and Plasma Flows, Tomsk Russia, 25-29 Jul. 2004 p43-48] which is incorporated by reference in its entirety. It should be noted that the process described in the incorporated papers relates to titanium and steel electron beam polishing while the present embodiments relate specifically to aluminum beam polishing. Aluminum electron beam polishing requires the electron beam polishing machine to use substantially different parameters and beam widths than used with steel and titanium. For example an electron beam associated with convention electron beam polishing of titanium or steel generally has a much smaller effective electron beam diameter than the electron beam adapted for aluminum which has an effective diameter of about 20-30 mm. In FIG. 4 a block diagram showing components associated with electron beam polishing machine 400 is illustrated. Electron beam emitter 402 can emit electron beam 404 which general has a Gaussian distribution where just outside a 20-30 mm diameter a power level associated with electron beam 404 drops to about 60% of maximum power. At a diameter of about 46 mm effectiveness drops off completely. Furthermore, the electron beam can effective polish an aluminum surface up to about 30 degrees off axis, at which point effectiveness of the beam drops off rapidly. It should be noted that in some applications a diameter of the electron beam can be reduced to about 10 mm. Electron beam emitter 402 is electrically coupled to trigger 406, arc 408 and accelerating voltage source 410. Emitted electron beam 404 can come in contact with a surface of workpiece 412. Workpiece manipulator 414 can keep electron beam 404 scanning across a surface of workpiece 412. Also of note is that due to the gradual attenuation of the electron beam polishing effect, one way to create a sharp distinction between electron beam affected portions and non-electron beam portions is by masking portions of a surface where electron beam polishing is not desired. The following parameters were found to produce acceptable results with electron beam polishing machine 400 when applied to aluminum: an accelerating voltage of between 5 and 25 kV; magnetic coil current of about 5A in an upper coil and 2A in a bottom coil; and electron beam pulse duration between about 50 and 200 μs with an accompanying pulse frequency of 1-10 Hz.

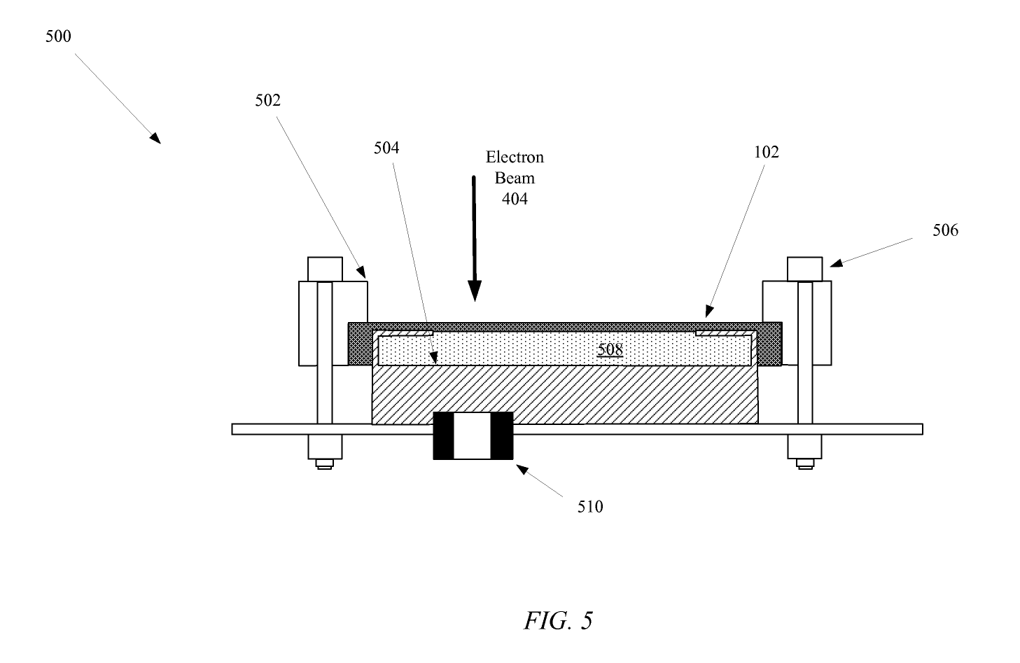

FIG. 5 illustrates heat transporting fixture 500. Heat transporting fixture 500 is configured to support hollow aluminum housing 102 during an electron beam polishing operation. In this embodiment aluminum housing 102 can have a thickness as small as about 0.6 mm. Consequently, application of an electron beam 404 can result in excessive heating of aluminum housing 102. In order to prevent warpage or other heat related changes when aluminum housing 102 is thin, aluminum housing 102 can be placed in a heat transporting fixture as shown in FIG. 5 that acts as a heat exchanger by removing substantial amounts of excess thermal energy deposited in the thin aluminum housing by electron beam 404. Heat transporting fixture can also provide mechanical support for aluminum housing 102. In one embodiment application of electron beam 404 can cause a transfer of energy of 10 J/cm², resulting in temperature increases of over 300K. To mitigate such an occurrence heat transporting fixture 500 has a water cooling system built into it for efficiently remove heat from aluminum housing 102, thereby preventing overheating of aluminum housing 102 during an electron beam polishing operation. Heat transporting fixture 500 includes Teflon® holder 502 which functions to hold an upper surface of aluminum housing 102 in place against heat transporting fixture housing 504. Teflon® holders 502 are secured by metal holders 506 Heat transporting fixture conduit 504 includes water channel 508 which is designed to carry cooling water along a lower surface of aluminum housing 102. Cooling water can be driven through water channel 508 by a pump circulating the cooling water through water channel 508. In some configurations aluminum housing 102 can be in direct contact with water channel 508 preventing an air gap during a heat transfer process and providing increased heat transfer efficiency. In other embodiments a closed system can be desired in which an upper wall is included as part of heat transporting fixture housing 504 between water channel conduit 508 and aluminum housing 102 so a water source can remain enclosed within a closed system. Permanent ring magnet 510 can be arranged along a lower surface of heat transporting fixture 500 to help focus the electron beam during an electron beam polishing operation. It should be noted that in some cases electron beam polishing of solid aluminum parts may not require heat transporting fixture 500 due to larger mass and/or lower susceptibility to deformation of the aluminum part.

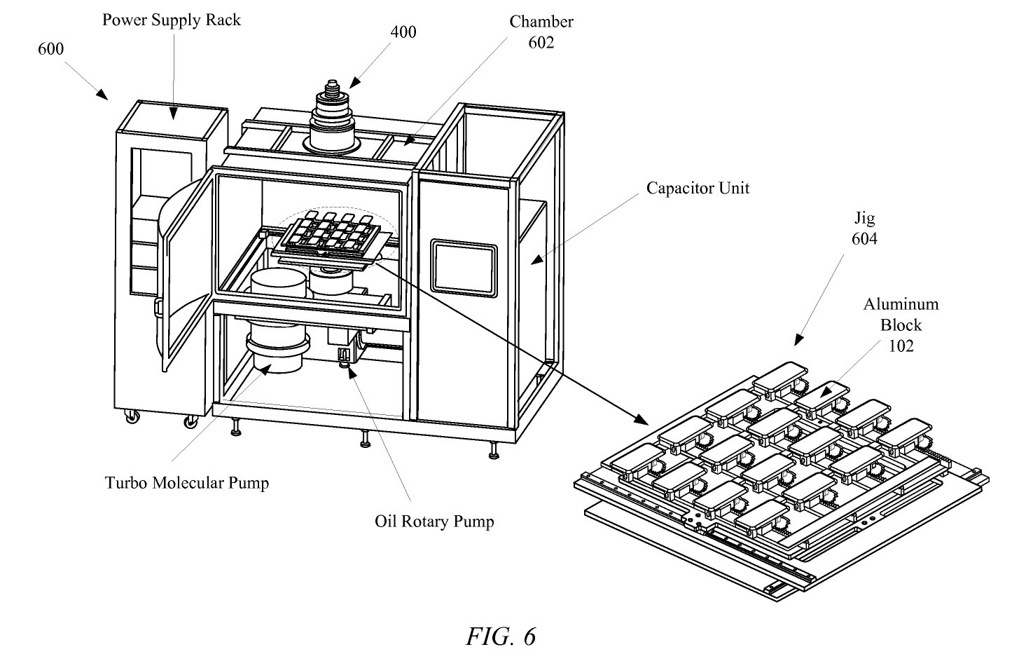

FIG. 6 illustrates an electron beam polishing machine 600. Electron beam polishing machine 600 includes a number of smaller components assisting in its function specifically annotated on FIG. 6. Of particular interest electron beam polishing is accomplished in near vacuum conditions consequently, electron beam polishing machine 600 includes a chamber 602 configured to create a vacuum for electron beam polishing machine 400 to operate in. In one set of trials pressure within the vacuum was about 0.06 Pa. Where electron beam polishing is established as part of a high volume manufacturing process a series of sluice chambers can be set up on either side of chamber 602. In this way while a number of aluminum parts are being subject to electron beam polishing another set of aluminum parts can be depressurized in an adjacent first sluice chamber. Upon completion of an electron beam polishing operation aluminum parts 102 can be transferred to a pressurizing second sluice chamber prior to depressurized aluminum parts being moved into chamber 602. In this way a continuous electron beam polishing operation can be sustained without having to wait for time consuming pressurization and depressurization steps after each electron beam polishing operation. Electron beam polishing machine 600 also includes jig 604 configured to maneuver a number of aluminum parts under electron beam 404. It should be noted that an electron beam polishing machine 600 can utilize the aforementioned parameters to electron beam polish a die cast aluminum automotive piston head in a car engine. The process is largely the same however due to a larger volume of the aluminum piston head cooling processes previously described may not be required.

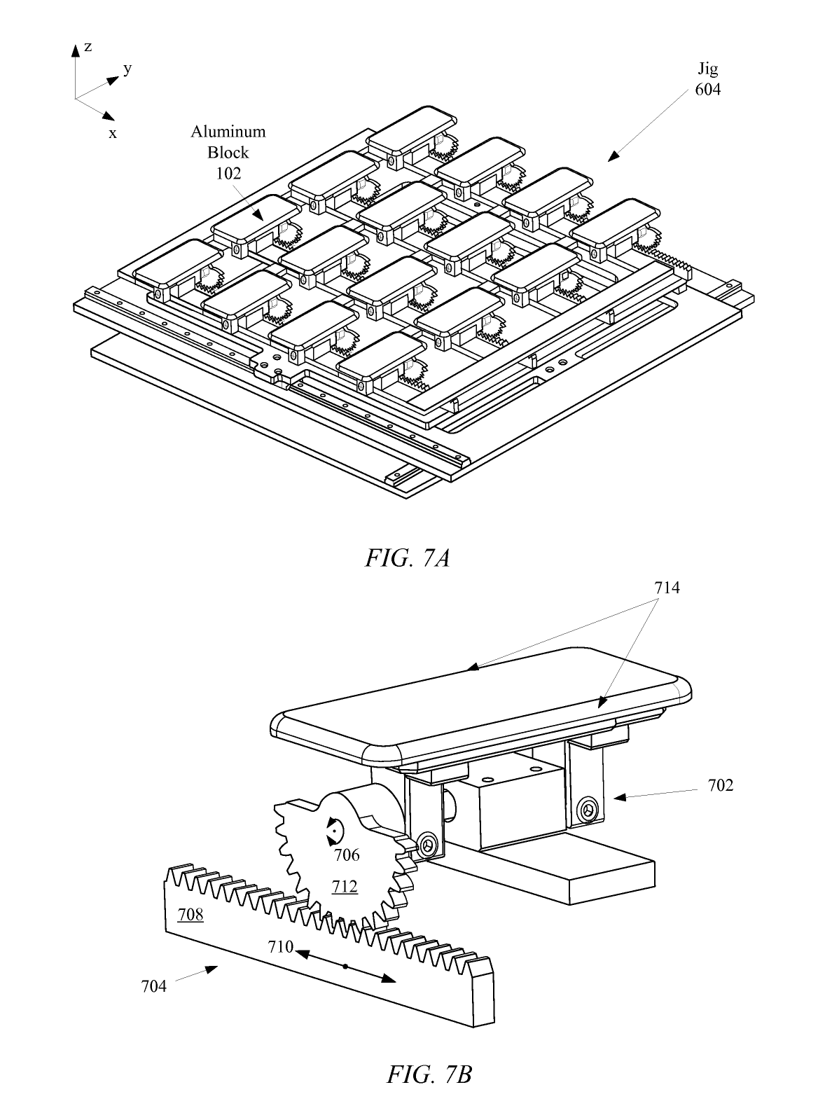

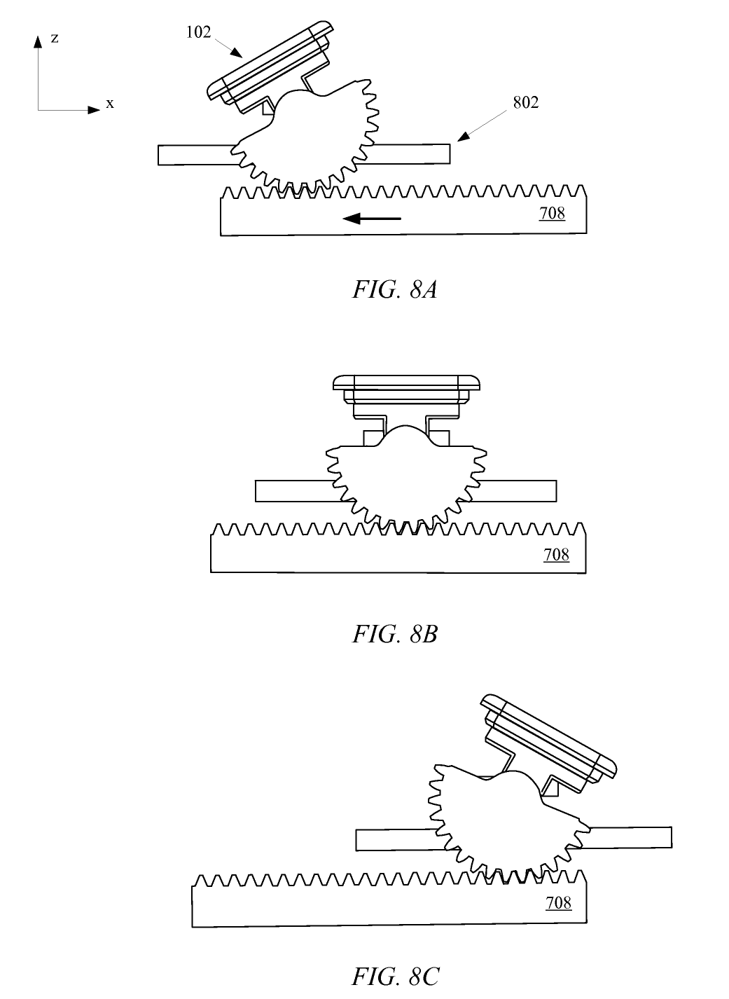

FIG. 7A illustrates a larger view of jig 604. Jig 604 can translate a group of aluminum parts 102 along X and Y axes separately or simultaneously. This translation can be controlled by a computer numerical controller as part of a computer controlled manufacturing process. Motion of jig 604 during the manufacturing operation can allow aluminum parts 102 to pass under electron beam 404 (not shown) at a speed of about 20 mm/sec. Depending on the size of aluminum parts 102 a number of passes of electron beam 404 across a surface of aluminum parts 102 can be used to completely apply a polishing effect across an entire surface of one of aluminum parts 102. Jig 604 can also include jig fasteners 702, as depicted in FIG. 7B. Jig fasteners 702 can be configured to rotate aluminum parts 102 during an electron beam polishing operation. Jig fastener 702 includes gearing system 704 that allows for rotation of aluminum housing 102 around rotation axis 706. Jig fastener can be rotated by maneuvering gear teeth 708 in direction 710. Movement of gear teeth 708 cause gear 712 to rotate which will is illustrated in FIGS. 8A-8C. Since electron beam 404 can lose significant polishing effectiveness when presented with a surface oriented more than 30 degrees from it, jig fastener 702 can assist in an electron beam polishing operation by orienting edge portions 714 of aluminum parts 102 towards electron beam 404 during appropriate intervals during an electron beam polishing operation. It should be noted that in some embodiments a heat transporting fixture can be included in jig fastener 702 thereby allowing electron beam polishing of either a thin hollowed out aluminum part or a solid aluminum part as depicted.

FIG. 8A-8C show rotation of aluminum part 102 with respect to jig fastener 702. In FIG. 8A jig fastener 702 is rotated in one direction. Since gear 712 is mechanically coupled to jig fastener 702, jig fastener 702 rotates with gear 712 while jig fastener support beam 802 can retain its orientation within the rest of jig 604. In FIG. 8B as gear teeth 708 are translated in the X-axis aluminum part 102 returns to a position parallel with a surface portion of jig 604. Finally, in FIG. 8C continued translation of gear teeth in the X-axis cause aluminum part 102 to be oriented in a direction opposite the first direction. In this way electron beam 404 can have convenient access to edge portions 714 of aluminum parts 102 during a polishing operation.

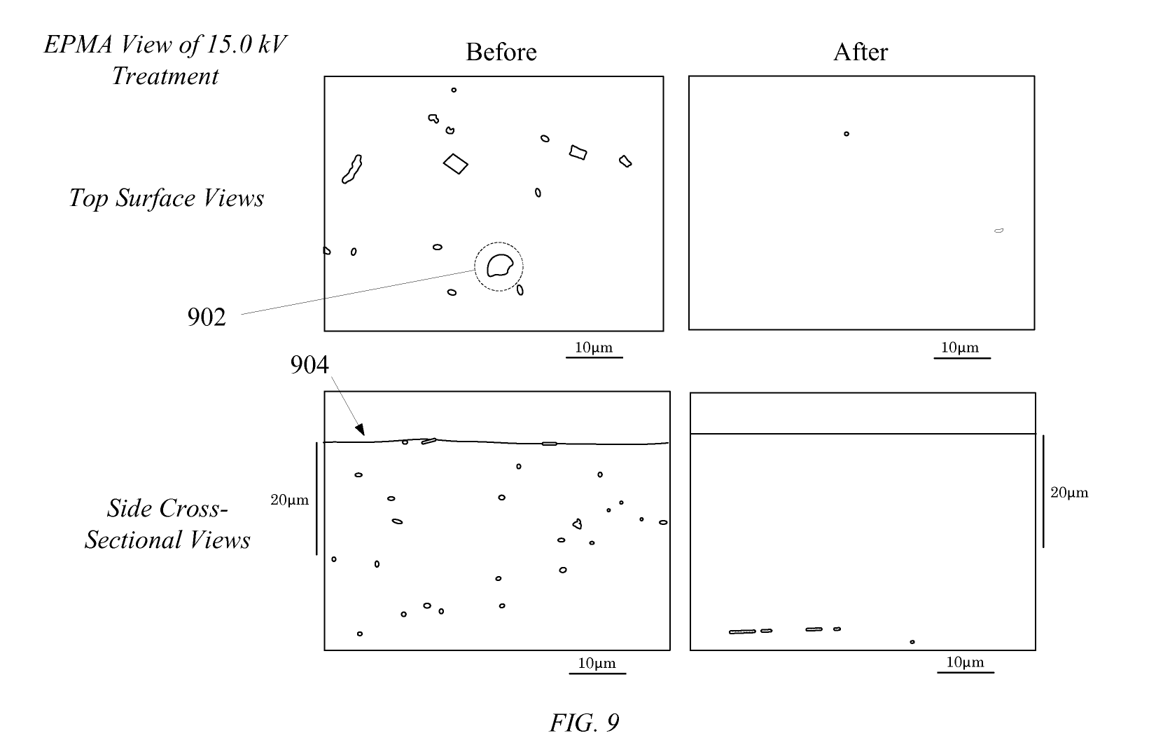

FIG. 9 shows results of an electron beam polishing operation as observed by an electron probe micro-analyzer (EPMA). An EPMA is quite similar to a scanning electron microscope with an additional capability of being able to conduct chemical analysis. The displayed results are based on use of a 15 kV accelerating voltage with the electron beam polishing machine. Before and after view of the top surface show a drastic reduction in intermetallic compounds 902. Intermetallic compounds 902 are not part of the alloy in the aluminum substrate and exist as inclusions in the substrate. In some embodiments intermetallic compounds can be an alloy containing a mix of Aluminum, Iron and Silicone. While not evident in this black and white drawing, residual traces and tooling marks along a surface portion of the aluminum substrate are also substantially eliminated by the electron beam polishing operation. Side cross-section views show a substantial flattening of aluminum surface 904 after the electron beam polishing operation is complete. Furthermore, while intermetallic compounds are generally only removed from the first 10-20 microns from the surface in this particular trial intermetallic compounds are substantially absent from over 30 microns into the surface.

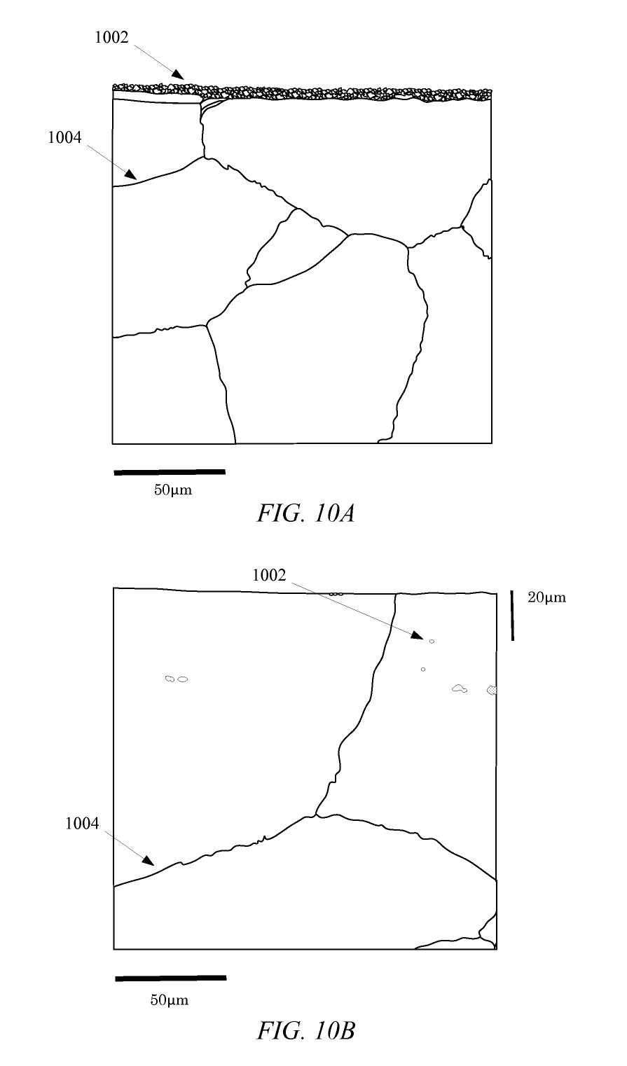

FIG. 10A shows a cross-sectional side view of machined aluminum substrate prior to an electron beam polishing operation. This view is provided by an electron backscatter diffraction pattern (EBSP). EBSP pictures show a crystallographic orientation of the materials within the machined aluminum substrate generally used to show texture or preferred orientation of the polycrystalline material. EBSP also involves the use of a scanning electron microscope but also includes an electron backscatter diffraction detector, which yields an electron backscatter diffraction pattern. FIG. 10A clearly shows a large concentration of intermetallic compounds 1002 arranged along a surface portion of an aluminum substrate. Also present in this depiction are grain boundaries 1004 which represent different orientations of aluminum within the substrate. FIG. 10B shows a cross-section side view of a machined aluminum substrate subsequent to an electron beam polishing operation. Of primary interest is that intermetallic compounds 1002 are almost completely absent from an upper surface of the aluminum substrate. Furthermore, intermetallic compounds aren't present until about 20 microns deep into the aluminum substrate. Grain boundaries are also substantially enlarged after the electron beam polishing operation. Grain boundaries are much more spread apart, and more closely aligned than in FIG. 10A, thereby yielding a smoother surface finish for the aluminum substrate. Furthermore, since intermetallic compounds have been evacuated from a surface portion of the aluminum substrate mechanical polishing operations can provide an even finer polished consistency for the aluminum substrate.

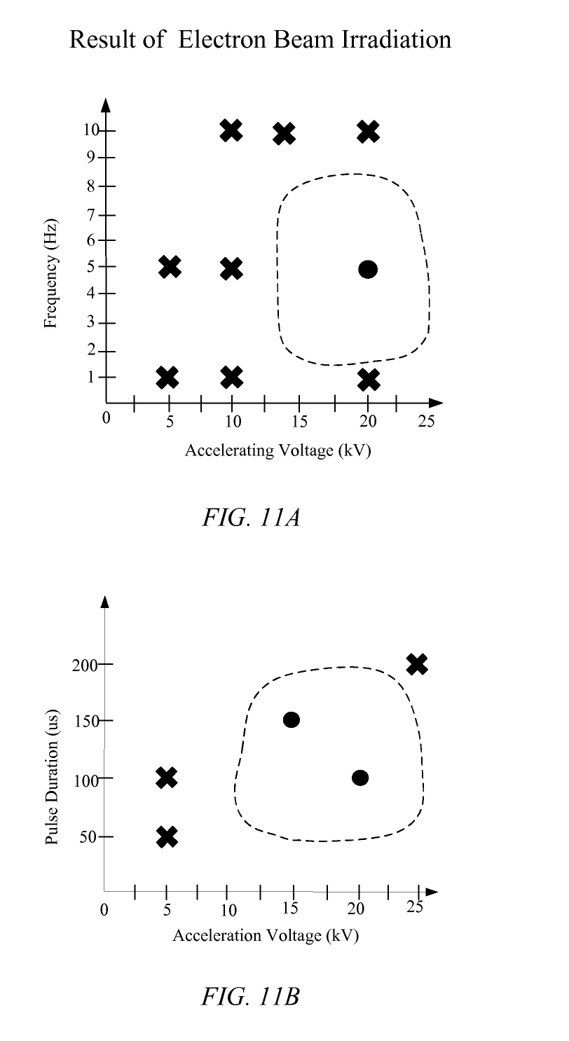

FIGS. 11A and 11B show parameter diagrams for an electron beam polishing machine useful in polishing aluminum. Circles demonstrate favorable results while crosses show unfavorable results. The displayed results were gathered with a coil current of 5A and 2A is applied respectively to upper and bottom the magnetic coils, and further when the targeted aluminum substrate is about 1.4 mm thick with a scanning speed of 20 mm/sec. It should be noted that FIG. 11A uses a fixed pulse duration of 100 μs and FIG. 11B uses a fixed pulse frequency of 5 Hz. In FIG. 11A shows a representation of pulse frequencies and accelerating voltages that achieve favorable results. When pulse frequency is set too high (in this case above 9 Hz) grain boundaries and craters between scanning lines begin to appear along a surface portion of an aluminum substrate. When accelerating voltage is set too low (in this case below 15 kV a resulting electron beam (EB) layer (essentially penetration of homogenous surface) does not penetrate deeply enough to withstand mechanical polishing operations. In FIG. 11B an accelerating voltage of less than 10 kV results in a thin EB layer with the aforementioned problems. A pulse duration of between 50 and 180 μs results in favorable results. However, river patterns begin to form in the surface of an aluminum substrate at a pulse duration of 200 μs. River patterns and scanning lines can be deep enough that mechanical polishing operations applied to remove them can grind away a created EB layer, thereby sacrificing any advantages associated with the process.

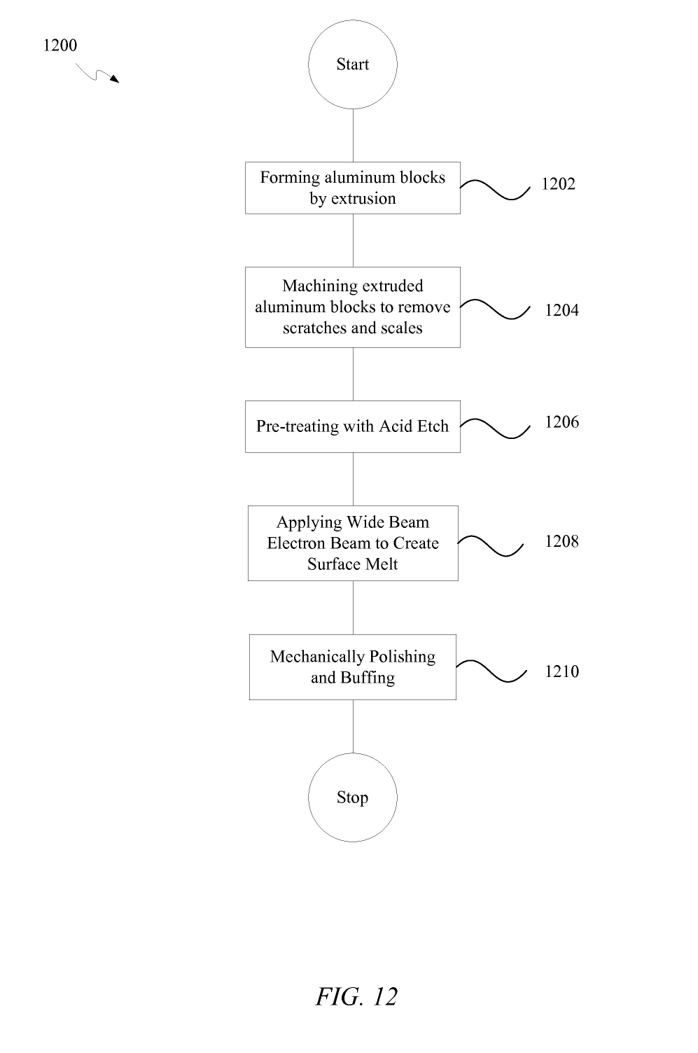

FIG. 12 shows a high level block diagram describing a process 1200 for forming and polishing an aluminum substrate. In a first step 1202 of process 1200 a number of aluminum parts are formed by an extrusion process. The extruded aluminum part can be made from an aluminum alloy such as ASTM A6063. In step 1204 a machining tool can be used to remove large scratches and scales from the extruded aluminum parts. In some embodiments the machining process can also create features along the extruded aluminum part or even hollow out the aluminum part for use as a housing. The machining operations create spot heating along a surface portion of the extruded aluminum parts resulting in a number of intermetallic compounds becoming embedded in a surface portion of the aluminum parts. In step 1206 an acid etching process is applied to the aluminum parts. The acid etching process takes place in an acid bath that includes a solution by weight of Phosphoric Acid (H₃PO₄: 66-71 wt %), and Nitric Acid (HNO₃: 5-9 wt %). The acid etching can be applied to large batches of aluminum parts arranged inside of a tray holder. The tray holder can be immersed in an acid bath prepared at a temperature of between about 60° C. to about 75° C. During the acid etching process the aluminum substrates can be vibrated to help stimulate an electro-polishing process by creating a solid state electrode potential gap between the aluminum parts and titanium alloy plates arranged within the plate holder. Iron wires can be placed in contact with the aluminum bars and titanium alloy plates further increasing effectiveness of the acid etching process. Subsequent to the acid etching pre-treatment in step 1208 a wide beam electron beam can be applied to create a surface melt across surface portions of the electron beam. By applying high amounts of energy to surface portions of the aluminum parts intermetallic compounds generated during the earlier machining process can be evaporated or exfoliated, thereby creating a substantially homogenous surface layer that is well suited for mechanical polishing operations. In step 1210 a mechanical polishing and buffing process can be employed. In general, the effective buffing depth is in the range of nanometers or at most a micron depth, therefore, it is clear that the intermetallic compounds which exist deeper than 10 to 20 microns do not affect the buffing process. However, since the electron beam create a surface melt of at least 10-20 microns, the superficial intermetallic compounds (i.e., within 10-20 microns of the surface) can be effectively eliminated. It should be noted that in some embodiments a subsequent anodization or sand blasting process can be applied to certain portions of the polished surface. By masking out a portion of the polished surface during the anodization process shiny shapes and text can be distinctly surrounded by a more muted matte surrounding.

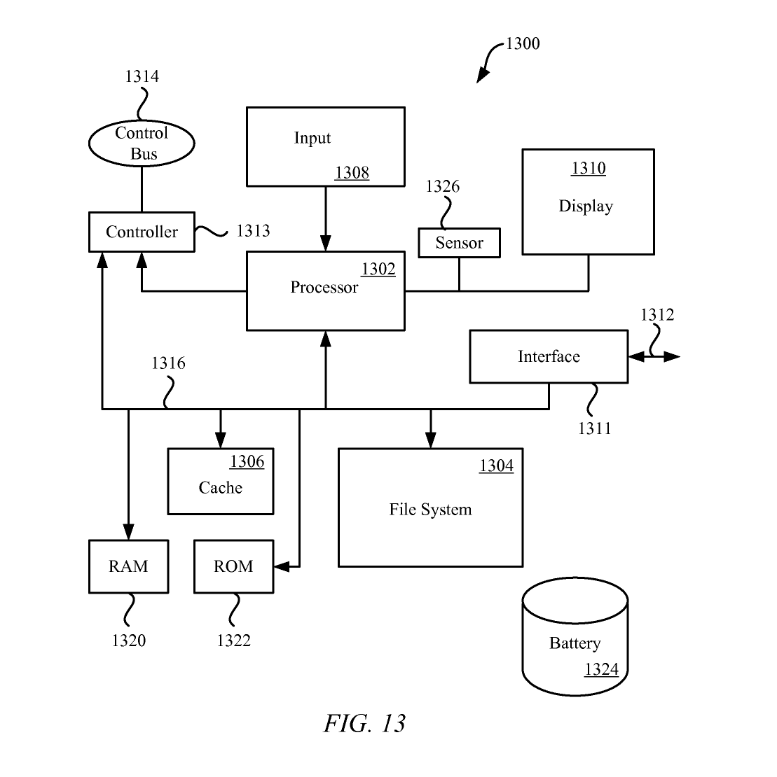

FIG. 13 is a block diagram of an electronic device suitable for controlling some of the processes in the described embodiment. Electronic device 1300 can illustrate circuitry of a representative computing device. Electronic device 1300 can include a processor 1302 that pertains to a microprocessor or controller for controlling the overall operation of electronic device 1300. Electronic device 1300 can include instruction data pertaining to manufacturing instructions in a file system 1304 and a cache 1306. File system 1304 can be a storage disk or a plurality of disks. In some embodiments, file system 1304 can be flash memory, semiconductor (solid state) memory or the like. The file system 1304 can typically provide high capacity storage capability for the electronic device 1300. However, since the access time to the file system 1304 can be relatively slow (especially if file system 1304 includes a mechanical disk drive), the electronic device 1300 can also include cache 1306. The cache 1306 can include, for example, Random-Access Memory (RAM) provided by semiconductor memory. The relative access time to the cache 1306 can substantially shorter than for the file system 1304. However, cache 1306 may not have the large storage capacity of file system 1304. Further, file system 1304, when active, can consume more power than cache 1306. Power consumption often can be a concern when the electronic device 1300 is a portable device that is powered by battery 1324. The electronic device 1300 can also include a RAM 1320 and a Read-Only Memory (ROM) 1322. The ROM 1322 can store programs, utilities or processes to be executed in a non-volatile manner. The RAM 1320 can provide volatile data storage, such as for cache 1306

Electronic device 1300 can also include user input device 1308 that allows a user of the electronic device 1300 to interact with the electronic device 1300. For example, user input device 1308 can take a variety of forms, such as a button, keypad, dial, touch screen, audio input interface, visual/image capture input interface, input in the form of sensor data, etc. Still further, electronic device 1300 can include a display 1310 (screen display) that can be controlled by processor 1302 to display information to the user. Data bus 1316 can facilitate data transfer between at least file system 1304, cache 1306, processor 1302, and controller 1313. Controller 1313 can be used to interface with and control different manufacturing equipment through equipment control bus 1314. For example, control bus 1314 can be used to control a computer numerical control (CNC) mill, a press, an injection molding machine or other such equipment. For example, processor 1302, upon a certain manufacturing event occurring, can supply instructions to control manufacturing equipment through controller 1313 and control bus 1314. Such instructions can be stored in file system 1304, RAM 1320, ROM 1322 or cache 1306.

Electronic device 1300 can also include a network/bus interface 1311 that couples to data link 1312. Data link 1312 can allow electronic device 1300 to couple to a host computer or to accessory devices. The data link 1312 can be provided over a wired connection or a wireless connection. In the case of a wireless connection, network/bus interface 1311 can include a wireless transceiver. Sensor 1326 can take the form of circuitry for detecting any number of stimuli. For example, sensor 1326 can include any number of sensors for monitoring a manufacturing operation such as for example a Hall Effect sensor responsive to external magnetic field, an audio sensor, a light sensor such as a photometer, computer vision sensor, a temperature sensor to monitor a chemical reaction and so on.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method of polishing a surface of an aluminum part, comprising:
chemically pre-treating the aluminum part by acid etching the aluminum part; and
electron beam processing the acid etched surface of the aluminum part by an electron beam, the electron beam processing characterized by:
an accelerating voltage of the electron beam between about 10 and 25 kV,
an electron beam pulse duration between about 50 and 150 micro seconds,
an electron beam pulse frequency between about 1 and 10 Hz, and
scanning a surface portion of the aluminum part with the electron beam,
wherein a resulting surface melt of the surface of the aluminum part eliminates substantially all intermetallic compounds and substantially enlarges grain boundaries of the surface of the aluminum part.

2. The method as recited in claim 1, further comprising:
mechanically polishing the processed surface of the aluminum part.

3. The method as recited in claim 2, wherein during the electron beam processing the aluminum part is mechanically coupled to a heat exchanger, the heat exchanger comprising:
a fixture for supporting the aluminum part;
a plurality of holders for securing the aluminum part to the fixture;
a conduit running through the fixture; and
a pump for circulating cooling water through the conduit,
wherein the heat exchanger prevents deformation and warpage of the aluminum part by preventing an overheating condition.

4. The method as recited in claim 3, wherein an upper portion of the conduit is open causing the cooling water to be in direct contact with a surface of the aluminum part, thereby facilitating direct conductive heat transfer between the cooling water and the aluminum part.

5. The method as recited in claim 2, wherein the scanning the surface portion of the aluminum part comprises scanning the surface portion of the aluminum part with the electron beam at a speed of about 20 mm per second.

6. The method as recited in claim 2, wherein the electron beam processing removes intermetallic compounds from a portion of the aluminum part extending from the surface of the aluminum part to a depth of about 20 microns beneath the surface of the aluminum part.

7. The method as recited in claim 4, wherein the electron beam is about 25 mm in diameter.

8. An electron beam polishing machine configured to polish an aluminum part, comprising:
an electron beam emitter;
a vacuum chamber; and
a jig configured to translate the aluminum part in at least two axes,
wherein the electron beam emitter is configured to operate during an electron beam polishing operation with an accelerating voltage of between about 10 and 25 kV, a pulse duration of between about 50 and 150 micro seconds, and a pulse frequency of between about 1 and 10 Hz, and wherein the translation of the aluminum part causes an emitted electron beam to scan across a surface of the aluminum part, causing a resulting surface melt of the surface of the aluminum part, thereby eliminating substantially all intermetallic compounds and substantially enlarging grain boundaries of the surface of the aluminum part.

9. The electron beam polishing machine as recited in claim 8, wherein variations along a surface portion of the aluminum part are substantially reduced by an acid etching process performed prior to use with the electron beam polishing machine.

10. The electron beam polishing machine as recited in claim 9, further comprising a heat transporting fixture mechanically coupling the aluminum part to the jig, the heat transporting fixture comprising:
a fixture for supporting the aluminum part;
a plurality of holders for securing the aluminum part to the fixture;
a conduit running through the fixture; and
a pump for rapidly circulating cooling water through the conduit.

11. The electron beam polishing machine as recited in claim 10, wherein the jig is configured to rotate the aluminum part about at least one axis of rotation with respect to the fixture of the heat exchanger.

12. The electron beam polishing machine as recited in claim 11, wherein the at least one axis of rotation allows edge portions of the aluminum part to be arranged towards the electron beam emitter during the electron beam polishing operation.

13. The electron beam polishing machine as recited in claim 9, wherein the vacuum chamber is configured with at least two sluice chambers for continuously operating the electron beam polishing machine.

14. The electron beam polishing machine as recited in claim 9, wherein the electron beam emitter is configured to provide a beam having an effective electron beam polishing diameter of between about 20 mm and 30 mm.

15. The electron beam polishing machine as recited in claim 9, wherein a surface melt across a surface portion of the aluminum part substantially removes intermetallic compounds within about 20 microns of the surface of the aluminum part.

16. The electron beam polishing machine as recited in claim 9, wherein the aluminum part is about 0.6 mm thick.

17. A polishing assembly for polishing an aluminum part, comprising:
a means for acid etching the aluminum part;
a means for configuring an electron beam with a set of operating parameters, the operating parameters comprising:
an accelerating voltage of between about 10 and 25 kV,
a pulse duration of between about 50 and 150 micro seconds, and
a pulse frequency of between about 1 and 10 Hz;
a means for activating the electron beam; and
a means for maneuvering an aluminum part through the electron beam so that the electron beam scans across substantially all of a surface of the aluminum part.

18. The polishing assembly as recited in claim 17, wherein the activated electron beam can effectively polish surfaces oriented up to about 30 degrees away from it.

19. The polishing assembly as recited in claim 17, further comprising:
a means for mechanically polishing the surface of the aluminum part subsequent to an electron beam polishing operation.

20. The polishing assembly as recited in claim 17, wherein an actively cooled heat sink is mechanically coupled to the aluminum part to remove heat during an electron beam polishing operation.
